(19) United States
(12) Patent Application Publication
(10) Pub. No.: US 2026/0296896 A1
(43) Pub. Date: Oct. 1, 2026

(54) CARBON DIOXIDE REACTION DEVICE

(71) Applicant: Yueqing Wanyin Aquarium Equipment Co., Ltd, Yueqing (CN)

(72) Inventor: Xiaopeng GAN, Yueqing (CN)

(21) Appl. No.: 19/537,553

(22) Filed: Feb. 12, 2026

(30) Foreign Application Priority Data
Mar. 26, 2025 (CN) 202520547942.5

(51) Int. Cl. C01B 32/50

(52) U.S. Cl. CPC C01B 32/50; C01B 2203/1638; C01B 2203/1647

(57) ABSTRACT

A carbon dioxide reaction device includes a first storage component defined with a first chamber for storing acidic substance, a second storage component defined with a second chamber for storing alkaline substance, and a pump body configured to draw and input the acidic substance into the second chamber or draw and input the alkaline substance into the first chamber. A gas pressure in an environment where the pump body operates is equal to gas pressures of the first chamber and the second chamber. During drawing, the pump body does not need to overcome a pressure difference for drawing operation, making the drawing operation more convenient. Using the pump body to draw the acidic substance into the alkaline substance achieves a stable conveying effect. Through the pump body, a volume of the acidic substance drawn can be stably and accurately controlled, thereby precisely controlling a volume of carbon dioxide generated.

### TECHNICAL FIELD

The disclosure relates to the technical field of aquariums, and more particularly to a carbon dioxide reaction device.

### BACKGROUND

A Chinese patent application with a publication No. CN113145023A discloses a carbon dioxide reaction device. During an actual research and development process, the applicant discovers that a pump body is struggling during operation. After a long period of experimentation, it is found that due to the pump body being located at a normal atmospheric pressure, gas pressures inside chambers where acid and alkali are located change during preparing carbon dioxide, resulting in a pressure difference between the gas pressures inside the chambers and the normal atmospheric pressure, making it very difficult for the pump body to draw, and sometimes even impossible to draw.

### SUMMARY

A technical problem to be solved by the disclosure is how to solve a drawing problem of a pump body. Therefore, the disclosure provides a carbon dioxide reaction device, including a first storage component, a second storage component, and a pump body. The first storage component defines a first chamber configured to store an acidic substance. The second storage component defines a second chamber configured to store an alkaline substance. The pump body is configured to draw the acidic substance from the first chamber and input the acidic substance into the second chamber, or the pump body is configured to draw the alkaline substance from the second chamber and input the alkaline substance into the first chamber. A gas pressure in an environment where the pump body operates is equal to a gas pressure of the first chamber and a gas pressure of the second chamber.

Firstly, the first chamber, the second chamber, and the environment where the pump body operates are set at an equal pressure, so that there is no pressure difference among them. At this time, during drawing, the pump body does not need to overcome the pressure difference for drawing operation, making the drawing operation more convenient. Using the pump body to draw the acidic substance into the alkaline substance achieves a stable conveying effect. Through the pump body, a volume of the acidic substance drawn can be stably and accurately controlled, thereby precisely controlling a volume of carbon dioxide generated.

In an embodiment, the carbon dioxide reaction device further includes a housing. The housing defines a third chamber configured to accommodate the pump body.

By accommodating the pump body in the third chamber, a control effect can be achieved by simply controlling a gas pressure of the third chamber to make the gas pressure in the environment where the pump body operates equal to the gas pressure of the first chamber and the gas pressure of the second chamber.

In an embodiment, the first storage component and the second storage component are individually connected to the housing. The first chamber, the second chamber, and the third chamber are connected to each other.

The first storage component and the second storage component are individually connected to the housing to form an integrated modular structure, making the carbon dioxide reaction device convenient for overall sales. Through connection among the first chamber, the second chamber, and the third chamber, an effect of equal gas pressure is formed.

In an embodiment, a first channel and a second channel are disposed on the housing. The first channel is configured to connect the pump body to the first chamber and the second chamber. The second channel is connected to the first chamber, the second chamber, and the third chamber.

The first channel is configured to transport liquid. The second channel is configured to achieve an effect of gas circulation, thereby connecting the first chamber, the second chamber, and the third chamber. The first channel and second channel can be internal structures of the housing, or they can be internally disposed through air pipes or water pipes.

In an embodiment, the second channel includes a first branch, a second branch, and a third branch. The first branch is configured to connect the second chamber to an output end of the carbon dioxide reaction device. The second branch is configured to connect the first chamber to the second chamber. The third branch is configured to connect the second chamber to the third chamber.

In the embodiment, the second chamber is a reaction chamber. The acidic substance from the first chamber is drawn and input into the second chamber to form an acid-base neutralization reaction, to thereby generate the carbon dioxide. The carbon dioxide generated is divided into multiple paths. A first path of the carbon dioxide is conveyed through the output end of the carbon dioxide reaction device to supply the carbon dioxide to an external fish tank. A second path of the carbon dioxide is used to connect the first chamber to the second chamber, making the gas pressure of the first chamber equal to the gas pressure of the second chamber. A third path of the carbon dioxide is used to connect the second chamber to the third chamber, making the gas pressure of the third chamber equal to the gas pressure of the second chamber.

In an embodiment, the second channel includes the first branch, the second branch, and the third branch. The first branch is configured to connect the second chamber to the output end of the carbon dioxide reaction device. The second branch is configured to connect the first chamber to the second chamber. The third branch is configured to connect the first chamber to the third chamber.

In this embodiment, the second chamber is the reaction chamber. Different from the above description, a connection pattern of the third branch changes, which is equivalent to the carbon dioxide entering the first chamber first, and then the second chamber being connected to the third chamber through the first chamber. An advantage of this design is that foam will be generated after reaction in the reaction chamber, and when an opening is directly defined on the reaction chamber, the foam will enter the third chamber through the third branch, causing the third chamber to be wet, and the pump body disposed inside the third chamber is prone to corrosion.

In an embodiment, the housing includes a cover plate, a base, and a pedestal. The cover plate is configured to cooperate with the base to define the third chamber. The base is configured to cooperate with the pedestal to define a fourth chamber. The first storage component and the second storage component are accommodated inside the fourth chamber.

The housing fixes the pump body, the first storage component, and the second storage component together, forming an integrated structure when the carbon dioxide reaction device is manufactured. In this way, a customer can use the carbon dioxide reaction device without assembly, making operation more convenient and improving operation convenience for the customer.

In an embodiment, the first channel and the second channel are disposed on the base.

In the embodiment, during processing of the base, such as injection molding, the first channel and the second channel are integrally formed on the base, achieving an integrated structure without need for wiring, making the operation simpler.

In an embodiment, the carbon dioxide reaction device further includes a regulating valve. The regulating valve is accommodated inside the third chamber and is located between the second storage component and the output end of the carbon dioxide reaction device.

Disposition of the regulating valve realizes control of the output end of the carbon dioxide reaction device.

In an embodiment, the carbon dioxide reaction device further includes a housing and a fixing piece. The fixing piece defines a fifth chamber, and the pump body is accommodated inside the fifth chamber. A first channel and a second channel are disposed on the housing. The first channel is configured to connect the pump body to the first chamber and the second chamber, and the second channel is connected to the first chamber, the second chamber, and the fifth chamber.

The fixing piece forms a modular structure with the pump body, which is easy to install and fix, has a simple structure, and reduces processing difficulty. The first channel and the second channel are pipes, which are connected by joints to realize connection of gas or liquid flow channels.

In an embodiment, the pump body is disposed in the first chamber or the second chamber.

Disposing the pump body in the first chamber makes the gas pressure in the environment where the pump body operates equal to the gas pressure of the first chamber. Only by connecting the first chamber to the second chamber can an equal pressure effect among the environment where the pump body operates, the first chamber, and the second chamber be achieved. The pump body can also be accommodated in the second chamber, and the equal pressure effect can also be achieved.

In an embodiment, the carbon dioxide reaction device further includes a controller configured to control operation of the pump body. The controller can be disposed inside the third chamber or outside the third chamber.

The controller can be disposed inside the housing or outside the housing.

In the embodiment, the controller can be remotely controlled by Bluetooth^{TM}, an application (APP), a local area network, or Internet of Things (IoT).

The Bluetooth^{TM}, the APP, the local area network, and the IoT can all play a control role, and the customer can achieve rapid control of the controller in different ways.

In an embodiment, a power supply for the controller can be direct current or alternating current. A voltage of the power supply can be 220 volts (V), 36 V, 24 V or 12 V.

### BRIEF DESCRIPTION OF DRAWINGS

In order to more clearly illustrate embodiments of the disclosure or technical solutions in related art, a brief introduction will be given to attached drawings required for description of the embodiments or the related art. Apparently, the attached drawings described below are part of the embodiments of the disclosure. For those skilled in the art, other attached drawings can be obtained based on these attached drawings without creative labor.

FIG. 1 illustrates a schematic structural diagram of a carbon dioxide reaction device according to an embodiment of the disclosure.

FIG. 2 illustrates a local schematic structural diagram of the carbon dioxide reaction device according to the embodiment of the disclosure.

FIG. 3 illustrates a sectional view of the carbon dioxide reaction device according to the embodiment of the disclosure.

FIG. 4 illustrates a perspective view of a base of the carbon dioxide reaction device according to the embodiment of the disclosure.

FIG. 5 illustrates a perspective view of another base of the carbon dioxide reaction device according to the embodiment of the disclosure.

FIG. 6 illustrates a schematic diagram of liquid flow according to the embodiment of the disclosure.

FIG. 7 illustrates a schematic diagram of gas flow according to the embodiment of the disclosure.

FIG. 8 illustrates a schematic structural diagram of another carbon dioxide reaction device according to an embodiment of the disclosure.

FIG. 9 illustrates a schematic structural diagram of further another carbon dioxide reaction device according to an embodiment of the disclosure.

FIG. 10 illustrates a schematic structural diagram of still another carbon dioxide reaction device according to an embodiment of the disclosure.

FIG. 11 illustrates a schematic structural diagram of yet another carbon dioxide reaction device according to an embodiment of the disclosure.

FIG. 12 illustrates a sectional view of the yet another carbon dioxide reaction device illustrated in FIG. 11.

FIG. 13 illustrates a sectional view of the yet another carbon dioxide reaction device illustrated in FIG. 11 from another view.

### DETAILED DESCRIPTION OF EMBODIMENTS

Technical solutions of the disclosure will be described clearly and completely as follows with reference to attached drawings. Apparently, embodiments described below are a part of embodiments of the disclosure, not all of them. Based on the embodiments of the disclosure, all other embodiments obtained by those skilled in the art without creative labor shall fall within a scope of protection of the disclosure.

In description of the disclosure, it should be noted that directional or positional relationships indicated by terms “center”, “up”, “down”, “left”, “right”, “vertical”, “horizontal”, “inside”, and “outside” are based on directional or positional relationships illustrated in the attached drawings and are only for convenience of describing technical solutions of the disclosure and simplifying the description, and do not indicate or imply that a device or an element referred to must have a specific orientation or be constructed and operated in a specific orientation, and therefore cannot be understood as limiting the disclosure. In addition, terms “first”, “second” and “third” are only used for descriptive purposes and cannot be understood as indicating or implying relative importance.

In the description of the disclosure, it should be noted that, unless otherwise specified and limited, terms “install”, “connect”, and “link” should be broadly understood; for example, it can be a fixed connection, a detachable connection, or an integrated connection; it can be a mechanical connection or an electrical connection; it can be a direct connection or an indirect connection through an intermediate medium; and it can be a connection within two components. For those skilled in the art, specific meanings of the above terms in the disclosure can be understood according to specific situations.

In addition, technical features involved in different embodiments of the disclosure described below can be combined with each other as long as they do not conflict with each other.

### Embodiment 1

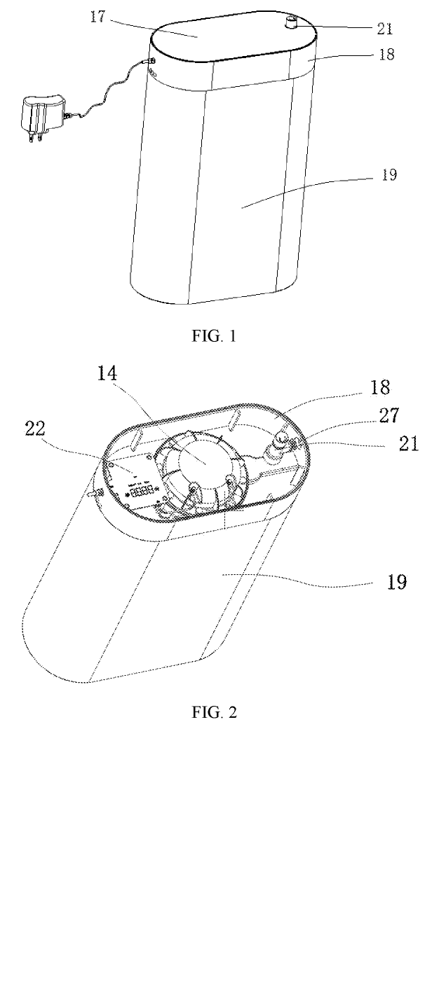

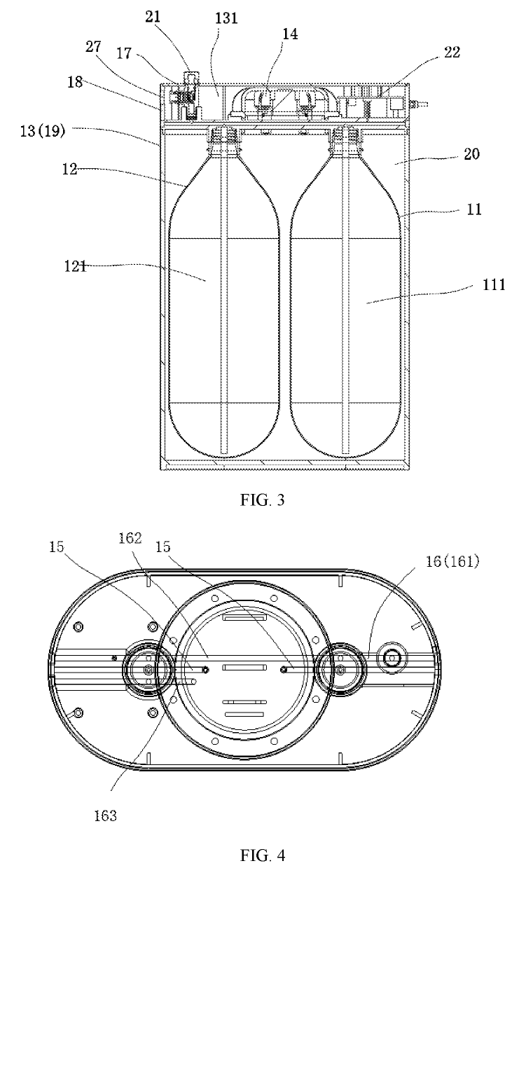

A carbon dioxide reaction device provided by the embodiment, as illustrated in FIGS. 1 through FIG. 7, includes a first storage component 11, a second storage component 12, and a pump body 14.

The first storage component 11 defines a first chamber 111 configured to store an acidic substance. The acidic substance is specifically an acid used for reaction to generate carbon dioxide and can be selected according to actual needs. In this embodiment, the acidic substance is in a liquid form.

The second storage component 12 defines a second chamber 121 configured to store an alkaline substance. The alkaline substance is used to neutralize the acidic substance to generate the carbon dioxide. In this embodiment, the alkaline substance is specifically in a solid powder form.

The pump body 14 is configured to draw the acidic substance from the first chamber 111 and input the acidic substance into the second chamber 121; or, the pump body is configured to draw the alkaline substance from the second chamber 121 and input the alkaline substance into the first chamber 111. When the acidic substance and the alkaline substance are both in the liquid form, the pump body 14 can be adjusted according to the actual needs. When the acidic substance is in the liquid form and the alkaline substance is in a solid form, the pump body 14 needs to draw the acidic substance and input the acidic substance into the alkaline substance. In this embodiment, the acidic substance in the liquid form and the alkaline substance in the solid form are taken for description; that is, the pump body 14 draws the acidic substance from the first chamber 111 and inputs the acidic substance into the second chamber 121 containing the alkaline substance, forming an acid-base neutralization reaction. Accordingly, the second chamber 121 is a reaction chamber.

A gas pressure in an environment where the pump body 14 operates is equal to a gas pressure of the first chamber 111 and a gas pressure of the second chamber 121. The environment where the pump body 14 operates can be located in an independent chamber, and a gas pressure in the dependent chamber needs to be adjusted to be equal to the gas pressure of the first chamber 111 and the gas pressure of the second chamber 121. Alternatively, the pump body 14 can be accommodated in the first chamber 111, and the gas pressure in the environment where the pump body 14 operates can be made equal to the gas pressure of the first chamber 111 and the gas pressure of the second chamber 121 by connecting the first chamber 111 to the second chamber 121 or adjusting the first chamber 111 and the second chamber 121, so that the gas pressure of the first chamber 111 is equal to the gas pressure of the second chamber 121. Alternatively, the pump body 14 can be accommodated in the second chamber 121, and when the gas pressure of the first chamber 111 is equal to the gas pressure of the second chamber 121, the gas pressure in the environment where the pump body 14 operates is also equal. When the gas pressure in the environment where the pump body 14 operates is equal to the gas pressure of the first chamber 111 and the gas pressure of the second chamber 121, during drawing, the pump body 14 does not need to overcome a pressure difference for drawing operation, making the drawing operation more convenient. Using the pump body 14 to draw the acidic substance into the alkaline substance achieves a stable conveying effect. Through the pump body 14, a volume of the acidic substance drawn can be stably and accurately controlled, thereby precisely controlling a volume of the carbon dioxide generated.

In the embodiment, as illustrated in FIG. 1 through FIG. 3, the carbon dioxide reaction device further includes a housing 13. The housing 13 defines a third chamber 131 configured to accommodate the pump body 14. By accommodating the pump body 14 in the third chamber 131, a control effect can be achieved by simply controlling a gas pressure in the third chamber 131 to make the gas pressure in the environment where the pump body 14 operates equal to the gas pressure of the first chamber 111 and the second chamber 121. In addition, the pump body 14 can also be accommodated in the first chamber 111 or in the second chamber 121.

Specifically, as illustrated in FIG. 1 through FIG. 3, the first storage component 11 and the second storage component 12 are individually connected to the housing 13. The first chamber 111, the second chamber 121, and the third chamber 131 are connected to each other. The first storage component 11 and the second storage component 12 are individually connected to the housing 13 to form an integrated modular structure, making the carbon dioxide reaction device convenient for overall sales. Through connection among the first chamber 11, the second chamber 12, and the third chamber 13, an effect of equal gas pressure is formed.

Specifically, as illustrated in FIG. 4 through FIG. 7, a first channel 15 and a second channel 16 are disposed on the housing 13. The first channel 15 is configured to connect the pump body 14 to the first chamber 111 and the second chamber 121. The second channel 16 is connected to the first chamber 111, the second chamber 121, and the third chamber 131. The first channel 15 is configured to transport liquid. The second channel 16 is configured to achieve an effect of gas circulation, thereby connecting the first chamber 111, the second chamber 121, and the third chamber 131. In addition, the first channel 15 and second channel 16 can be internal structures of the housing 13, or they can be a gas channel and a liquid flow channel through cooperation of joints and the pipelines.

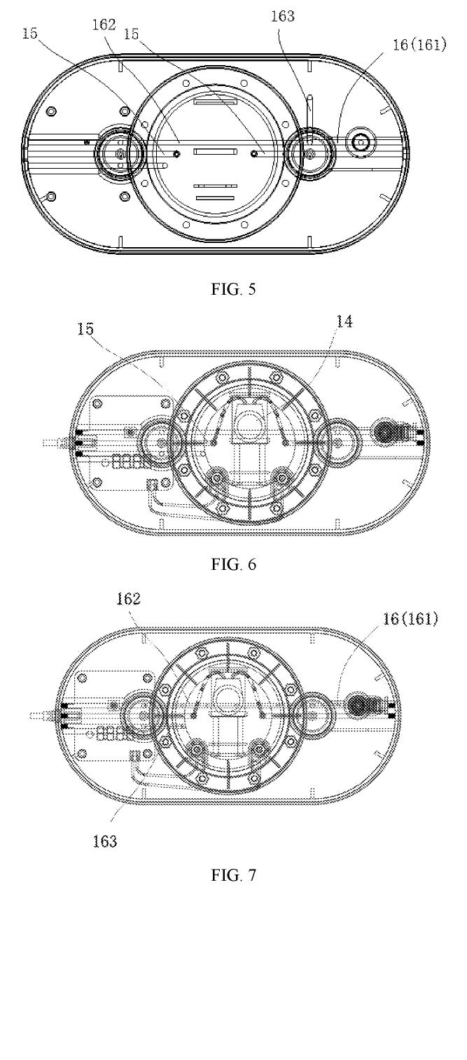

Specifically, as illustrated in FIG. 5, the second channel 16 includes a first branch 161, a second branch 162, and a third branch 163. The first branch 161 is configured to connect the second chamber 121 to an output end 27 of the carbon dioxide reaction device. The second branch 162 is configured to connect the first chamber 111 to the second chamber 121. The third branch is configured to connect the second chamber 121 to the third chamber 131. In the embodiment, the second chamber 121 is the reaction chamber. The acidic substance in the liquid form from the first chamber 111 is drawn and input into the second chamber 121 to form the acid-base neutralization reaction, to thereby generate the carbon dioxide. The carbon dioxide generated is divided into several paths. A first path of the carbon dioxide is conveyed through the output end 27 of the carbon dioxide reaction device to supply the carbon dioxide to an external fish tank. A second path of the carbon dioxide is used to connect the first chamber 111 to the second chamber 121, making the gas pressure of the first chamber 111 equal to the gas pressure of the second chamber 121. A third path of the carbon dioxide is used to connect the second chamber 121 to the third chamber 131, making the gas pressure of the third chamber 131 equal to the gas pressure of the second chamber 121.

Specifically, as illustrated in FIG. 4, the second channel 16 includes the first branch 161, the second branch 162, and the third branch 163. The first branch 161 is configured to connect the second chamber 121 to the output end 27 of the carbon dioxide reaction device. The second branch 162 is configured to connect the first chamber 111 to the second chamber 121. The third branch 163 is configured to connect the first chamber 111 to the third chamber 131. In this embodiment, the second chamber 121 is the reaction chamber. Different from the above description, a connection pattern of the third branch 163 changes, which is equivalent to the carbon dioxide entering the first chamber 111 first and then the second chamber 121 being connected to the third chamber 131 through the first chamber 111. An advantage of this design is that foam will be generated after reaction in the reaction chamber, and when an opening is directly defined on the reaction chamber, the foam will enter the third chamber 131 through the third branch 163, causing the third chamber 131 to be wet, and the pump body 14 disposed inside the third chamber 131 is prone to corrosion.

Specifically, as illustrated in FIG. 1 through FIG. 3, the housing 13 includes a cover plate 17, a base 18, and a pedestal 19. The cover plate 17 is configured to cooperate with the base 18 to define the third chamber 131. The base 18 is configured to cooperate with the pedestal 19 to define a fourth chamber 20. The first storage component 11 and the second storage component 12 are accommodated inside the fourth chamber 20. The first storage component 11 and the second storage component 12 are disposed independently. The first storage component 11 and the second storage component 12 are individually connected to the base 18, and connection patterns herein can be threaded connections, snap connections, or other connection patterns. The housing 13 fixes the pump body 14, the first storage component 11, and the second storage component 12 together, forming an integrated structure when the carbon dioxide reaction device is manufactured. In this way, a customer can use the carbon dioxide reaction device without assembly, making operation more convenient and improving operation convenience for the customer.

Specifically, the first channel 15 and the second channel 16 are disposed on the base 18. During processing of the base 18 herein, such as injection molding, the first channel 15 and the second channel 16 are integrally formed on the base 18, achieving an integrated processing effect without need for wiring, making the operation simpler. It should be noted that, the first channel 15 and the second channel 16 form five through holes connected to an outside, which can be sealed with plugs. In addition, those skilled in the art can also seal the five through holes through other sealing pieces.

Specifically, the cover plate 17, the base 18, and the pedestal 19 together enclose the third chamber 131 sealed, and the third chamber 131 can be sealed by sealing structures such as sealing rings.

Specifically, the carbon dioxide reaction device further includes a regulating valve 21. The regulating valve 21 is accommodated inside the third chamber 131 and is located between the second storage component 12 and the output end 27 of the carbon dioxide reaction device. Disposition of the regulating valve 21 realizes control of the output end 27 of the carbon dioxide reaction device.

Specifically, the carbon dioxide reaction device further includes a controller 22 configured to control operation of the pump body 14. The controller 22 can be disposed inside the third chamber 131 or outside the third chamber 131. The controller 22 can be disposed inside the housing 13 or outside the housing 13. The controller 22 herein controls the pump body 14 through a microcontroller or other programs, which is a technology in the art and will not be described further. In the embodiment, the controller 22 is a circuit board, and a sensor for detecting gas pressure is integrated onto the circuit board to monitor a value of the gas pressure in real time.

Specifically, the controller can be remotely controlled by Bluetooth^{TM}, an APP, a local area network, or IoT. The Bluetooth^{TM}, the APP, the local area network, and the IoT can all play a control role, and the customer can achieve rapid control of the controller in different ways.

Specifically, light-emitting diode (LED) lights can be fixed inside the fourth chamber 20. The LED lights are electrically connected to the controller. The controller can control operation of the LED lights. The LED lights provide illumination in low-light environments.

Specifically, a power supply for the controller can be direct current or alternating current. A voltage of the power supply can be 220 V, 36 V, 24 V or 12 V.

### Embodiment 2

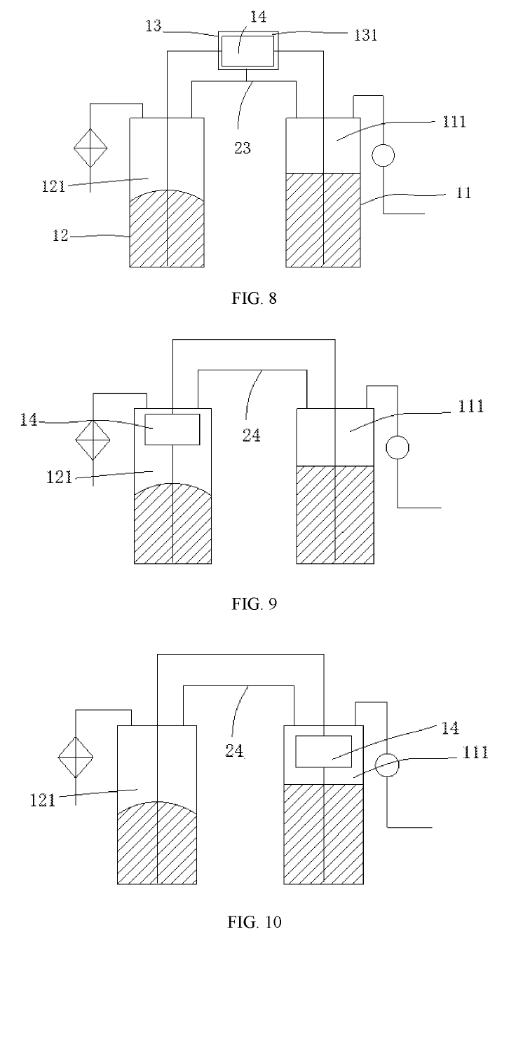

As illustrated in FIG. 8, the embodiment provides a carbon dioxide reaction device. Differences between the carbon dioxide reaction device provided by embodiment 2 and the carbon dioxide reaction device provided by embodiment 1 lie in that the carbon dioxide reaction device provided by embodiment 2 further includes a connecting pipe 23. The housing 13, the first storage component 11, and the second storage component 12 are disposed independently from each other. The connecting pipe 23 is connected to the first chamber 111, the second chamber 121, and the third chamber 131, and the connecting pipe 23 herein is a pipe for gas flow. Disposition of the connecting pipes 23 achieves connections among the first chamber 111, the second chamber 121, and the third chamber 131, making gas pressures of the three chambers equal. The connecting pipe 23 herein can be a gas pipe. In addition, it should be noted that the carbon dioxide reaction device also includes pipes for liquid transportation, that is, the acid substance in the liquid form flows into the second chamber 121 through the pump body 14 through the pipes for liquid transportation.

### Embodiment 3

As illustrated in FIGS. 9 and FIG. 10, the embodiment provides a carbon dioxide reaction device. Differences between the carbon dioxide reaction device provided by embodiment 3 and the carbon dioxide reaction device provided by embodiment 1 lie in that the carbon dioxide reaction device provided by embodiment 3 further includes a connecting piece 24. The connecting piece 24 is connected to the first chamber 111 and the second chamber 121. The pump body 14 is disposed inside the first chamber 111 or the second chamber 121.

### Embodiment 4

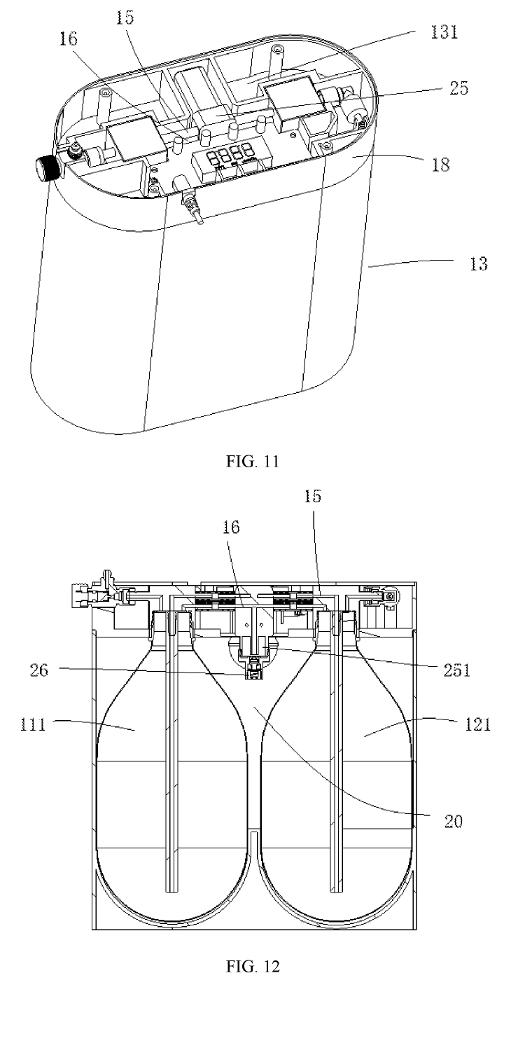

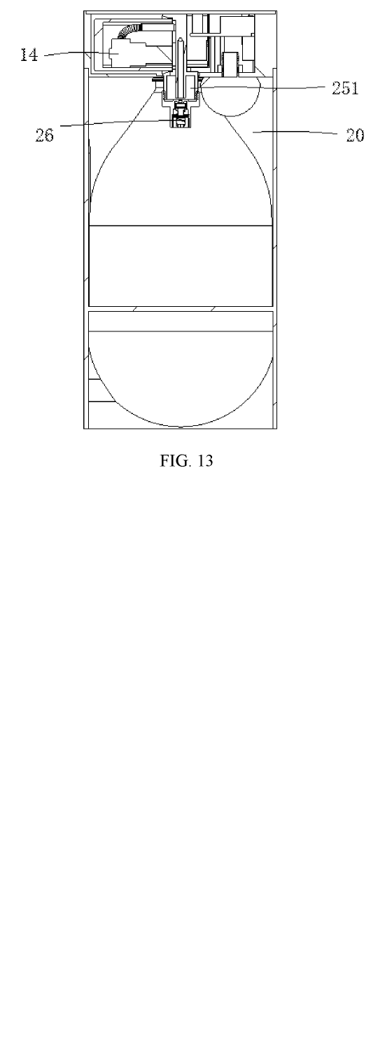

As illustrated in FIG. 11 through FIG. 13, the embodiment provides a carbon dioxide reaction device. Differences between the carbon dioxide reaction device provided by embodiment 4 and the carbon dioxide reaction device provided by embodiment 1 lie in that the carbon dioxide reaction device provided by embodiment 4 further includes the housing 13 and a fixing piece 25. The fixing piece 25 is disposed inside the third chamber 131 and connected to the base 18. The fixing piece 25 defines a fifth chamber 251, and the pump body 14 is accommodated inside the fifth chamber 251. The pump body 14 described herein partially extends into the fifth chamber 251 to seal the fifth chamber 251. The other part of the pump body 14 is located in the third chamber 131. At this time, the fifth chamber 251 is an independent and sealed chamber, and the fifth chamber 251 is not connected to the third chamber 131. In the embodiment, a front end of the pump body 14 extends to cooperate with the fifth chamber 251, and the gas pressure in the environment where the pump body 14 operates is a gas pressure of the fifth chamber 251. Those skilled in the art should understand that the fifth chamber 251 can be sealed by sealing means such as glue or sealing structures to form a sealed chamber. The housing 13 is provided with the first channel 15 and the second channel 16. The first channel 15 is configured to connect the pump body 14 to the first chamber 111 and the second chamber 121. The first channel 15 is used to transport liquid, and the pump body 14 injects the acid substance in the liquid form from the first chamber 111 into the second chamber 121. The second channel 16 is connected to the first chamber 111, the second chamber 121, and the fifth chamber 251. The second channel 16 is used to convey gas, achieving an equal pressure effect among the first chamber 111, the second chamber 121, and the fifth chamber 251. The fixing piece 25 forms a modular structure with the pump body 14, which is easy to install and fix, has a simple structure, and reduces processing difficulty. The first channel 15 and the second channel 16 are pipes, which are connected by joints to realize connection of gas or liquid flow channels. Moreover, a volume of the fifth chamber 251 is much smaller than that of the third chamber 131, and an advantage of small volume is that it can reduce interference of air. Before reaction, the third chamber 131 and the fifth chamber 251 both contain initial air (not vacuum environments), and the initial air has an impact on a concentration of the carbon dioxide produced by the reaction. However, a small volume of the fifth chamber 251 and a small volume of the initial air result in a higher concentration of carbon dioxide output from the carbon dioxide reaction device. The customer does not need to eliminate exhaust gas (low concentration gas) during using the carbon dioxide reaction device.

Specifically, a part of the fixing piece 25 extends through the third chamber 131 to the fourth chamber 20, and a pressure relief valve 26 is fixed to a part of the fixed piece 25 extending to the fourth chamber 20. The pressure relief valve 26 seals a lower end of the fifth chamber 251. The pressure relief valve 26 is used to discharge liquid out of the fifth chamber 251 when liquid infiltration occurs in the fifth chamber 251 during use, thereby improving a service life of the fixing piece 25.

Apparently, the above-mentioned embodiments are only examples for clear explanation and are not used to limit implementation methods of the disclosure. For those skilled in the art, other variations or changes in different forms can be made on a basis of the above description. It is not necessary and impossible to exhaust all the embodiments of the disclosure here. However, apparent variations or changes on the basis of the above description are still within a scope of protection of the disclosure.

What is claimed is:

1. A carbon dioxide reaction device, comprising:
a first storage component, defining a first chamber configured to store an acidic substance;
a second storage component, defining a second chamber configured to store an alkaline substance; and
a pump body, wherein the pump body is configured to draw the acidic substance from the first chamber and input the acidic substance into the second chamber; or, the pump body is configured to draw the alkaline substance from the second chamber and input the alkaline substance into the first chamber; and
wherein a gas pressure in an environment where the pump body operates is equal to a gas pressure of the first chamber and a gas pressure of the second chamber.

2. The carbon dioxide reaction device as claimed in claim 1, further comprising a housing, wherein the housing defines a third chamber configured to accommodate the pump body.

3. The carbon dioxide reaction device as claimed in claim 2, wherein the first storage component and the second storage component are individually connected to the housing, and the first chamber, the second chamber, and the third chamber are connected to each other.

4. The carbon dioxide reaction device as claimed in claim 3, wherein a first channel and a second channel are disposed on the housing; the first channel is configured to connect the pump body to the first chamber and the second chamber, and the second channel is connected to the first chamber, the second chamber, and the third chamber.

5. The carbon dioxide reaction device as claimed in claim 4, wherein the second channel comprises a first branch, a second branch, and a third branch; the first branch is configured to connect the second chamber to an output end of the carbon dioxide reaction device, the second branch is configured to connect the first chamber to the second chamber, and the third branch is configured to connect the second chamber to the third chamber.

6. The carbon dioxide reaction device as claimed in claim 4, wherein the second channel comprises a first branch, a second branch, and a third branch; the first branch is configured to connect the second chamber to an output end of the carbon dioxide reaction device, the second branch is configured to connect the first chamber to the second chamber, and the third branch is configured to connect the first chamber to the third chamber.

7. The carbon dioxide reaction device as claimed in claim 5, wherein the housing includes a cover plate, a base, and a pedestal; the cover plate is configured to cooperate with the base to define the third chamber; the base is configured to cooperate with the pedestal to define a fourth chamber, and the first storage component and the second storage component are accommodated inside the fourth chamber.

8. The carbon dioxide reaction device as claimed in claim 7, wherein the first channel and the second channel are disposed on the base.

9. The carbon dioxide reaction device as claimed in claim 8, further comprising a regulating valve, wherein the regulating valve is accommodated inside the third chamber and is located between the second storage component and the output end of the carbon dioxide reaction device.

10. The carbon dioxide reaction device as claimed in claim 9, further comprising a controller configured to control operation of the pump body, wherein the controller is disposed inside the third chamber.

11. The carbon dioxide reaction device as claimed in claim 1, further comprising a housing and a fixing piece; wherein the fixing piece defines a fifth chamber, the pump body is accommodated inside the fifth chamber; a first channel and a second channel are disposed on the housing; the first channel is configured to connect the pump body to the first chamber and the second chamber, and the second channel is connected to the first chamber, the second chamber, and the fifth chamber.

12. The carbon dioxide reaction device as claimed in claim 11, further comprising a pressure relief valve, wherein the pressure relief valve is fixed to the fixed piece, and the pressure relief valve is configured to discharge liquid out of the fifth chamber when liquid infiltration occurs in the fifth chamber.

13. The carbon dioxide reaction device as claimed in claim 1, wherein the pump body is disposed inside the first chamber or the second chamber.

14. A carbon dioxide reaction device, comprising:
a first storage component, defining a first chamber configured to store an acidic substance;
a second storage component, defining a second chamber configured to store an alkaline substance;
a pump body, wherein an end of the pump body is connected to the first storage component, and another end of the pump body is connected to the second storage component, and the pump body is configured to draw the acidic substance from the first chamber and input the acidic substance into the second chamber, or the pump body is configured to draw the alkaline substance from the second chamber and input the alkaline substance into the first chamber; and
a housing, wherein the first storage component, the second storage component, and the pump body are accommodated inside the housing; and
wherein a gas pressure in an environment where the pump body operates is equal to a gas pressure of the first chamber and a gas pressure of the second chamber.
